(19) United States
(12) Patent Application Publication
(10) Pub. No.: US 2023/0251130 A1
(43) Pub. Date: Aug. 10, 2023

(54) INFRARED RAMAN MICROSCOPE

(71) Applicant: SHIMADZU CORPORATION, Kyoto (JP)

(72) Inventors: Naoya FUJIWARA, Kyoto (JP); Yusuke AOI, Kyoto (JP); Yuri ITO, Kyoto (JP)

(73) Assignee: SHIMADZU CORPORATION, Kyoto (JP)

(21) Appl. No.: 18/071,620

(22) Filed: Nov. 30, 2022

(30) Foreign Application Priority Data
Feb. 4, 2022 (JP) 2022-016539

(51) Int. Cl. G01J 3/02; G01N 21/65; G01N 21/3563

(52) U.S. Cl. CPC G01J 3/027; G01N 21/65; G01N 21/3563

(57) ABSTRACT

An infrared Raman microscope capable of switching to and performing infrared spectroscopic analysis or Raman spectroscopic analysis for a sample on a stage includes an infrared light detection system, a Raman light detection system, a display unit, a display switching processing unit, and storage processing units. The infrared light detection system and the Raman light detection system photographs a visible image at different magnifications. The display unit displays the visible image of the sample in a display area in association with coordinates on the stage. The display switching processing unit switches and displays the visible image in the same image display area. In a case where a measurement position of the infrared spectroscopic analysis or the Raman spectroscopic analysis is designated on the display area, the storage processing units store a point of coordinates on the stage corresponding to the measurement position.

### CROSS REFERENCE TO RELATED APPLICATIONS

This application claims priority to Japanese Patent Application No. 2022-16539 filed on Feb. 4, 2022, the entire disclosure of which is incorporated by reference herein.

### BACKGROUND OF THE INVENTION

### Field of the Invention

The present invention relates to an infrared Raman microscope capable of switching to and performing infrared spectroscopic analysis or Raman spectroscopic analysis for a sample on a stage.

### Description of the Related Art

As analysis methods for performing analysis by irradiating a sample with light, infrared spectroscopic analysis and Raman spectroscopic analysis are known (see, for example, JP-A-2001-13095). In the infrared spectroscopic analysis, an infrared spectrum is obtained by irradiating a measurement position of a sample with infrared light and measuring light absorption at each wavelength (wave number). On the other hand, in the Raman spectroscopic analysis, a Raman spectrum is obtained by irradiating a measurement position of a sample with light of a specific wavelength and measuring scattered light (Raman scattered light) generated from the sample.

Both the infrared spectrum and the Raman spectrum are vibration spectra based on molecular vibration. The molecular vibration includes a vibration mode appearing as a peak on a spectrum and a vibration mode not appearing as a peak, and appearance of a peak is different between the infrared spectroscopic analysis by absorption and the Raman spectroscopic analysis by scattering. For this reason, if analysis is performed using both the infrared spectrum and the Raman spectrum, more types of substances can be identified.

### SUMMARY OF THE INVENTION

An operator performs operation of designating a measurement position of a sample when performing the infrared spectroscopic analysis and when performing the Raman spectroscopic analysis. If the measurement position of the sample in the infrared spectroscopic analysis and the measurement position of the sample in the Raman spectroscopic analysis are the same, a specific measurement position can be analyzed in detail. However, when switching between the infrared spectroscopic analysis and the Raman spectroscopic analysis, the operation of adjusting measurement points to the same measurement position in the analyses has been complicated.

In particular, in a case where the visible image of a sample photographed by an infrared photographing element during the infrared spectroscopic analysis and a visible image of the sample photographed by a Raman photographing element during the Raman spectroscopic analysis have different magnifications, the measurement position is sometimes designated after the magnification of each photographed visible image is adjusted. In this case, the operation of designating a measurement position becomes more complicated.

The present invention has been made in view of the above circumstances, and an object of the present invention is to provide an infrared Raman microscope in which it is easy to designate a measurement position when the infrared spectroscopic analysis or the Raman spectroscopic analysis is switched to and performed.

A first aspect of the present invention is an infrared Raman microscope capable of switching to and performing infrared spectroscopic analysis or Raman spectroscopic analysis on a sample on a stage, the infrared Raman microscope including an infrared light detection system, a Raman light detection system, a display unit, a display switching processing unit, and a storage processing unit. The infrared light detection system includes an infrared light source, an infrared spectrometer that receives reflected light from a sample irradiated with light from the infrared light source, and an infrared photographing element that photographs a visible image of a sample on the stage. The Raman light detection system includes a laser light source, a Raman spectrometer that receives Raman scattered light from a sample irradiated with light from the laser light source, and a Raman photographing element that photographs a visible image of a sample on the stage at a magnification different from that of the infrared photographing element. The display unit displays a visible image of a sample in a display area in association with coordinates on the stage. The display switching processing unit switches and displays a visible image photographed by the infrared photographing element or a visible image photographed by the Raman photographing element with respect to the same display area. When a measurement position of the infrared spectroscopic analysis or the Raman spectroscopic analysis is designated on the display area, the storage processing unit stores a point of coordinates on the stage corresponding to the measurement position.

According to the present invention, it is easy to designate a measurement position when the infrared spectroscopic analysis or the Raman spectroscopic analysis is switched to performed.

### BRIEF DESCRIPTION OF THE DRAWINGS

FIG. 1 is a schematic view illustrating an example of a configuration of an infrared Raman microscope.

FIG. 2 is a schematic view illustrating an example of a configuration of the infrared Raman microscope.

FIG. 3 is a block diagram illustrating an example of an electrical configuration of the infrared Raman microscope.

FIG. 4 is a diagram for explaining an aspect when a visible image of a sample is displayed.

FIG. 5 is a diagram for explaining an aspect when a visible image of a sample is associated with stage coordinates.

FIG. 6 is a schematic view illustrating an example of a position designation screen.

FIG. 7 is a functional block diagram illustrating a specific example of an electrical configuration of the infrared Raman microscope.

### DETAILED DESCRIPTION OF THE PREFERRED EMBODIMENTS

### 1. Schematic Configuration of Infrared Raman Microscope

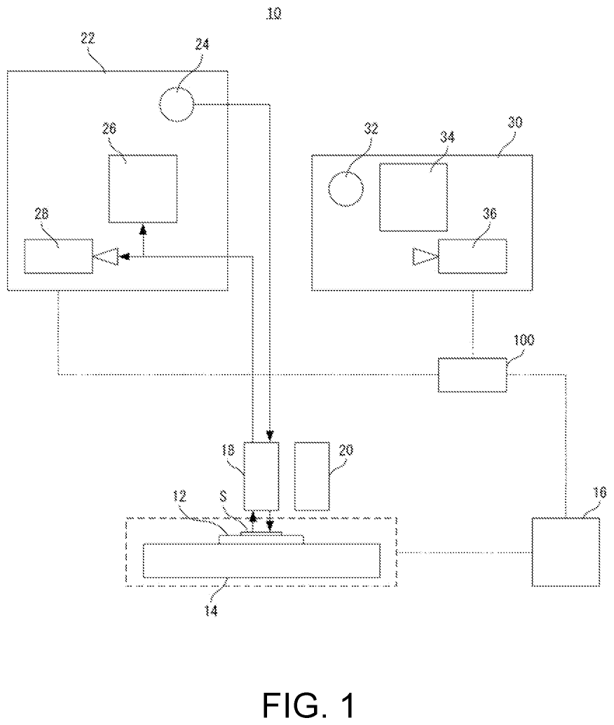

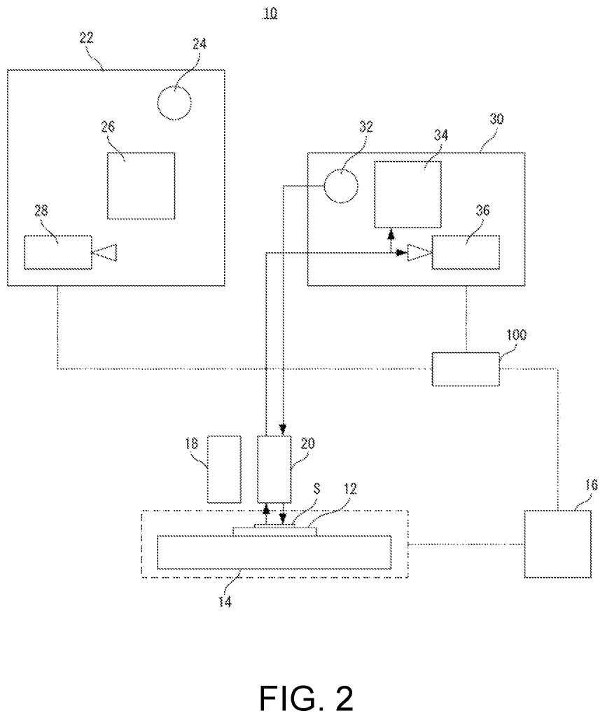

FIGS. 1 and 2 are schematic diagrams illustrating an example of a configuration of an infrared Raman microscope 10. The infrared Raman microscope 10 according to the present embodiment is a microscope that can switch to perform the Raman spectroscopic analysis and the infrared spectroscopic analysis on a sample S on a stage 14.

Further, FIG. 1 illustrates a state (Raman analysis state) of the infrared Raman microscope 10 when the Raman spectroscopic analysis is performed, and FIG. 2 illustrates a state (infrared analysis state) of the infrared Raman microscope 10 when the infrared spectroscopic analysis is performed.

The infrared Raman microscope 10 includes a plate 12, the stage 14, a drive unit 16, an objective optical element 18, an objective optical element 20, a Raman light detection system 22, an infrared light detection system 30, and the like. The sample S is placed on the stage 14 in a state of being fixed to the plate 12.

The stage 14 can be displaced in the horizontal direction or the vertical direction by driving of the drive unit 16. The drive unit 16 can be electrically controlled, and the drive unit 16 and the stage 14 are mechanically connected. The drive unit 16 includes, for example, a motor, a gear, and the like.

The objective optical element 18 is used for the Raman spectroscopic analysis, and has a configuration in which, for example, a convex lens and a concave lens are combined. When the Raman spectroscopic analysis is performed, as illustrated in FIG. 1, an objective optical element 18 faces the sample S on the plate 12. That is, the objective optical element 18 is located immediately above the sample S on the plate 12.

The objective optical element 20 is used for the infrared spectroscopic analysis, and is, for example, a Cassegrain mirror obtained by combining a concave mirror and a convex mirror. When the infrared spectroscopic analysis is performed, as illustrated in FIG. 2, the objective optical element 20 faces the sample S on the plate 12. That is, the objective optical element 20 is located immediately above the sample S on the plate 12.

The Raman light detection system 22 is used for performing the Raman spectroscopic analysis, and includes a light source 24, a Raman spectrometer 26, and an optical photographing element 28. Light emitted from the light source 24 is, for example, laser light having a wavelength in a visible range or a near-infrared range, and a wavelength of the laser light is about several μm to several tens μm. As illustrated in FIG. 1, when the Raman spectroscopic analysis is performed, light emitted from the light source 24 is guided to the objective optical element 18 by various optical elements (not illustrated).

Light incident on the objective optical element 18 is focused on the sample S fixed to the plate 12. That is, light from the light source 24 is condensed by being transmitted through the objective optical element 18, and is applied to a focal position on the sample S or in the sample S. Raman scattered light is generated from the sample S irradiated with light from the light source 24, and this light is guided to the Raman light detection system 22 by various optical elements (not illustrated). A part of light guided from the objective optical element 18 to the Raman light detection system 22 enters the optical photographing element 28, and the remaining light enters the Raman spectrometer 26.

The Raman spectrometer 26 detects intensity for each wavelength by dispersing the Raman scattered light from the sample S. Based on a detection signal from the Raman spectrometer 26, a Raman spectrum can be acquired. In a Raman spectrum, the vertical axis represents intensity, and the horizontal axis represents wavelength. As described above, in the infrared Raman microscope 10, a Raman spectrum can be acquired as the detector (Raman spectrometer 26) receives Raman scattered light from the sample S.

The optical photographing element 28 photographs a visible image of a surface of the sample S in which Raman scattered light is generated. The optical photographing element 28 includes, for example, a charge coupled device (CCD) image sensor, a complementary metal oxide semiconductor (CMOS) image sensor, or the like, and is configured to be able to photograph a still image or a moving image of the sample S. The optical photographing element 28 can photograph all or at least one of a bright field image, a dark field image, a phase difference image, a fluorescence image, a polarization microscope image, and the like of the sample S.

The infrared light detection system 30 is used for performing the infrared spectroscopic analysis, and includes a light source 32, an infrared spectrometer 34, and an optical photographing element 36. Light emitted from the light source 32 is, for example, infrared light emitted from a ceramic heater, and has a wavelength of about 405 nm to 1064 nm, and in many cases, light obtained by combining wavelengths of 532 nm and 785 nm is used. As illustrated in FIG. 2, when the infrared spectroscopic analysis is performed, light emitted from the light source 32 is guided to the objective optical element 20 by various optical elements (not illustrated).

Light incident on the objective optical element 20 is focused on the sample S fixed to the plate 12. That is, light from the light source 32 is condensed by being transmitted through the objective optical element 20, and is applied to a focal position on the sample S or in the sample S. Reflected light from the sample irradiated with light from the light source 32 is guided to the infrared light detection system 30 by various optical elements (not illustrated). A part of the light guided from the objective optical element 20 to the infrared light detection system 30 enters the optical photographing element 36, and the remaining light enters the infrared spectrometer 34.

The infrared spectrometer 34 is, for example, a Fourier transform infrared spectrometer. A spectroscope included in the infrared spectrometer 34 may be a Michelson interference spectroscope. The infrared spectrometer 34 detects intensity for each wavelength by dispersing reflected light of infrared light from the sample. An infrared spectrum can be acquired on the basis of a detection signal from the infrared spectrometer 34. In an infrared spectrum, the vertical axis represents intensity, and the horizontal axis represents wavelength. As described above, in the infrared Raman microscope 10, an infrared spectrum can be acquired as the detector (infrared spectrometer 34) receives reflected light of infrared light from the sample S.

The optical photographing element 36 photographs a visible image of a surface of the sample S from which infrared light is reflected. The optical photographing element 36 may have a configuration similar to that of the optical photographing element 28. Similarly to the optical photographing element 28, the optical photographing element 36 can photograph a still image or a moving image of the sample S, and can photograph all or at least one of a bright field image, a dark field image, a phase difference image, a fluorescence image, a polarization microscope image, and the like of the sample S.

Since the objective optical element 18 and the objective optical element 20 have different magnifications, a magnification when a visible image of the sample S is photographed by the optical photographing element 28 is different from a magnification when a visible image of the sample S is photographed by the optical photographing element 36. That is, a visible image of the sample S photographed by the optical photographing element 28 and a visible image photographed by the optical photographing element 36 have different magnifications.

As described above, in the infrared Raman microscope 10 according to the present embodiment, switching between the Raman analysis state and the infrared analysis state is enabled, and in a case where switching is made from the infrared analysis state to the Raman analysis state, a positional relationship between the objective optical element 18 and the plate 12 is adjusted, so that a focal position of light condensed by the objective optical element 18 is adjusted to a predetermined measurement position of the sample S. On the other hand, in a case where switching is made from the Raman analysis state to the infrared analysis state, a positional relationship between the objective optical element 20 and the plate 12 is adjusted, so that a focal position of light condensed by the objective optical element 20 is adjusted to a predetermined measurement position of the sample S.

### 2. Electrical Configuration of Infrared Raman Microscope

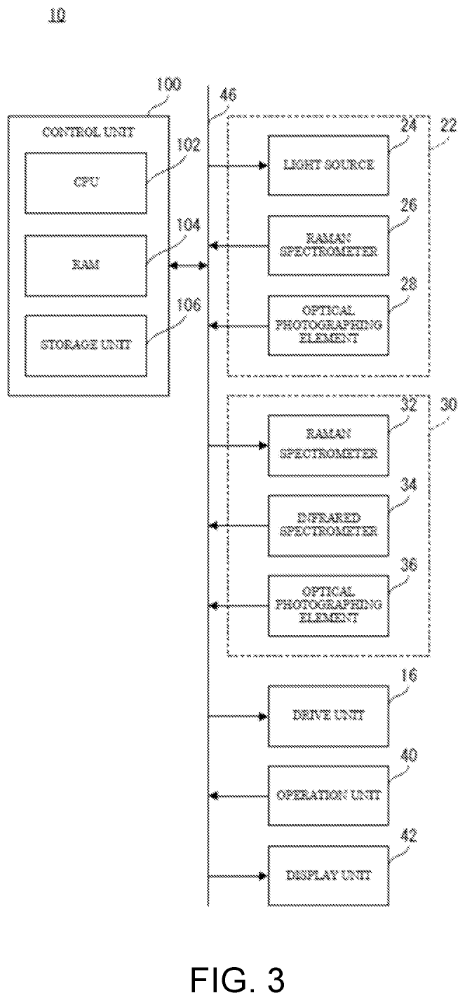

FIG. 3 is a block diagram illustrating an example of an electrical configuration of the infrared Raman microscope 10. The infrared Raman microscope 10 includes an operation unit 40, a display unit 42, a control unit 100, and the like in addition to the drive unit 16, the Raman light detection system 22, the infrared light detection system 30, and the like.

Further, each of the control unit 100, the drive unit 16, the light source 24, the Raman spectrometer 26, the optical photographing element 28, the light source 32, the infrared spectrometer 34, the optical photographing element 36, the operation unit 40, and the display unit 42 is electrically connected to each other via a circuit 46 such as a bus.

The control unit 100 is responsible for overall control of the infrared Raman microscope 10. The control unit 100 includes a central processing unit (CPU) 102. Further, the control unit 100 includes a random access memory (RAM) 104 and a storage unit 106 that can be directly accessed by the CPU 102.

The RAM 104 is used as a work area and a buffer area of the CPU 102. The storage unit 106 is a non-volatile memory, and for example, a hard disc drive (HDD), a solid state drive (SSD), or the like is used as the storage unit 106.

The storage unit 106 stores a control program for controlling the infrared Raman microscope 10, data (execution data) required for executing the control program, and the like. Note that the storage unit 106 may be configured to include the RAM 104.

The operation unit 40 includes a hardware key. Further, the operation unit 40 may include an input device. Examples of the input device include a keyboard and a mouse. Furthermore, the input device may include a touch panel. Note that, in this case, the touch panel is provided on a display surface of the display unit 42. Further, the touch panel and the display unit 42 may be integrally formed. Note that the display unit 42 is a general-purpose display.

### 3. Display of Visible Image of Sample

When the infrared spectroscopic analysis or the Raman spectroscopic analysis is performed, a visible image of the sample S is displayed on the display unit 42.

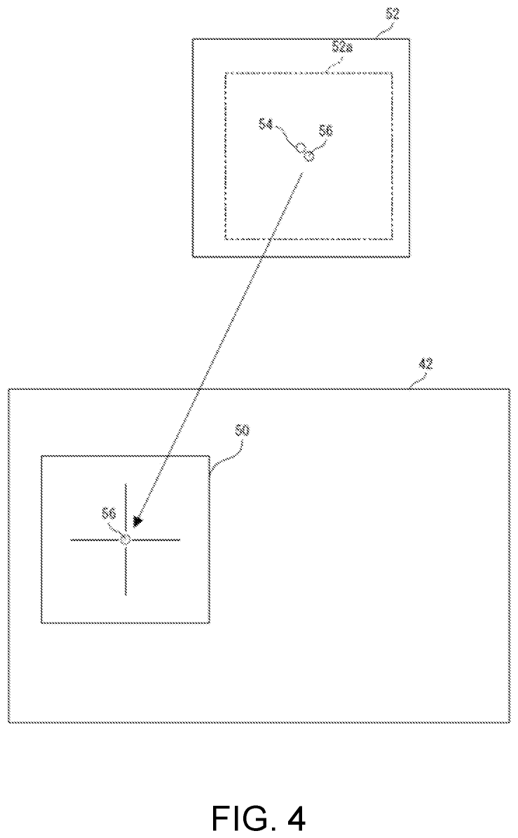

FIG. 4 is a diagram for explaining an aspect when a visible image of the sample S is displayed. When the infrared spectroscopic analysis or the Raman spectroscopic analysis is performed, a display screen including an image display area 50 is displayed on the display unit 42. That is, the image display area 50 is displayed on the display unit 42.

At this time, a visible image 52 of the sample S, specifically, a part 52a of the visible image 52 is displayed in real time in the image display area 50 on the basis of a signal from the optical photographing element 28 or the optical photographing element 36. However, the visible image 52 displayed in the image display area 50 may be a still image acquired at a predetermined timing.

Further, in the present embodiment, optical axis position information is stored in advance in the storage unit 106 in a data format. The optical axis position information is information indicating a deviation amount of an optical axis position 56 with respect to center 54 of the visible image 52. The optical axis position 56 is an optical axis position of light from the light source 24 or the light source 32. For example, the storage unit 106 stores optical axis position information corresponding to the objective optical element 18 and optical axis position information corresponding to the objective optical element 20.

In the present embodiment, the optical axis position information is used so that the visible image 52 is displayed in the image display area 50 such that the optical axis position 56 is at the center of the image display area 50.

Note that, in the present embodiment, size of the visible image 52 is larger than size of the image display area 50. For this reason, in the example illustrated in FIG. 4, the part 52a of the visible image 52 is displayed in the image display area 50. That is, the part 52a of the visible image 52 having the same size as the image display area 50 is cut out such that the optical axis position 56 is at the center, and is displayed in the image display area 50.

For example, when the infrared Raman microscope 10 is in the Raman analysis state, the visible image 52 photographed by the optical photographing element 28 is displayed in the image display area 50 such that the optical axis position 56 of light from the light source 24 is at the center. Further, when the infrared Raman microscope 10 is in the infrared analysis state, the visible image 52 photographed by the optical photographing element 36 is displayed in the image display area 50 such that the optical axis position 56 of light from the light source 32 is at the center.

Note that a deviation amount between the center 54 of the visible image 52 and the optical axis position 56 is different between the visible image 52 in the Raman analysis state photographed by the optical photographing element 28 and the visible image 52 in the infrared analysis state photographed by the optical photographing element 36. This is because an optical path relating to infrared spectroscopic analysis is different from an optical path relating to the Raman spectroscopic analysis.

### 4. Association Between Visible Image of Sample and Coordinates on Stage

When the visible image 52 of the sample S is displayed on the display unit 42 as the infrared spectroscopic analysis or the Raman spectroscopic analysis is performed, the visible image 52 is associated with coordinates (stage coordinates) on the stage 14.

Further, in the present embodiment, map information is stored in the storage unit 106 in a data format in advance. The map information is information indicating stage coordinates. Note that the stage coordinates are two-dimensional coordinates.

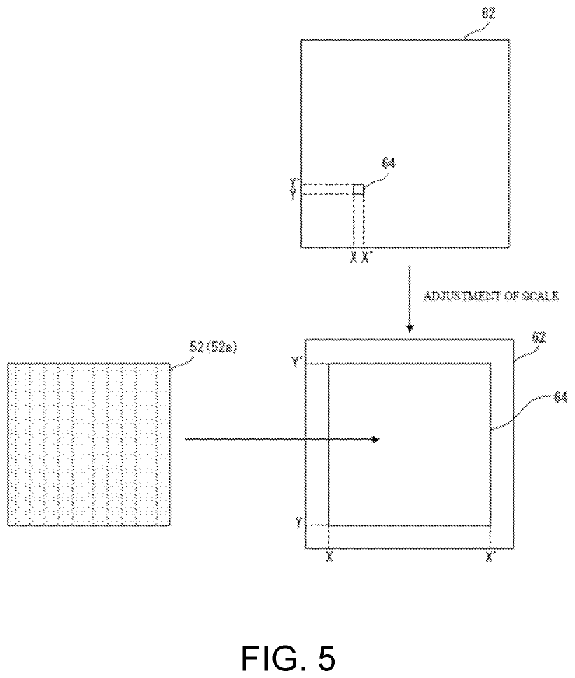

FIG. 5 is a diagram for explaining an aspect when the visible image 52 of the sample S is associated with stage coordinates. In the present embodiment, it is possible to identify a range of coordinates of a portion to be photographed by the optical photographing element 28 or the optical photographing element 36 on the stage 14, that is, a portion (photographed portion) 64 to be photographed on the stage 14.

A range of coordinates of the photographed portion 64 can be identified based on, for example, a moving distance and a moving direction of the stage 14 from a reference position and a magnification of the objective optical element 18 or the objective optical element 20. Note that, in such a case, the reference position of the stage 14 is set for each of the Raman analysis state and the infrared analysis state, and a moving distance and a moving direction of the stage 14 from the reference position are identified based on operation of the drive unit 4.

Further, the visible image 52 is an image obtained as the photographed portion 64 is photographed through the objective optical element 18 or the objective optical element 20. That is, the visible image 52 is an image obtained by enlarging the photographed portion 64 according to a magnification of the objective optical element 18 or the objective optical element 20.

In the present embodiment, the scale of the stage coordinates 62 is adjusted so that size of the photographed portion 64 in the image display area 50 matches size of the visible image 52, so that the visible image 52 and the stage coordinates 62 can be associated with each other. In this manner, when the visible image 52 is superimposed and displayed on the stage coordinates 62 on the image display area 50, the visible image 52 (the part 52a of the visible image 52) can be matched with the photographed portion 64.

Note that the scale of the stage coordinates 62 is adjusted so that enlargement is made according to a magnification when the visible image 52 is photographed, that is, a magnification of the visible image 52. That is, an adjustment amount of the scale of the stage coordinates 62 is determined by a magnification of the optical photographing element 28 or the optical photographing element 36.

In the present embodiment, scale information is stored in the storage unit 106 in a data format in advance. The scale information is information indicating an adjustment amount of the scale of the stage coordinates 62.

Since an adjustment amount of the scale of the stage coordinates 62 changes depending on a magnification when the visible image 52 is photographed, that is, a magnification of the visible image 52, a plurality of pieces of scale information is stored in the storage unit 106. For example, scale information corresponding to the objective optical element 18 and scale information corresponding to the objective optical element 20 are stored in the storage unit 106.

For example, when the infrared Raman microscope 10 is in the Raman analysis state, the visible image 52 photographed by the optical photographing element 28 is associated with the stage coordinates 62 for which the scale is adjusted according to a magnification of the visible image 52. Further, when the infrared Raman microscope 10 is in the infrared analysis state, the visible image 52 photographed by the optical photographing element 36 is associated with the stage coordinates 62 for which the scale is adjusted according to a magnification of the visible image 52.

### 4. Designation of Measurement Position

A measurement position when the infrared spectroscopic analysis or the Raman spectroscopic analysis is performed can be designated on the visible image 52 displayed on the display unit 42. The measurement position is an optional position selected in a horizontal plane.

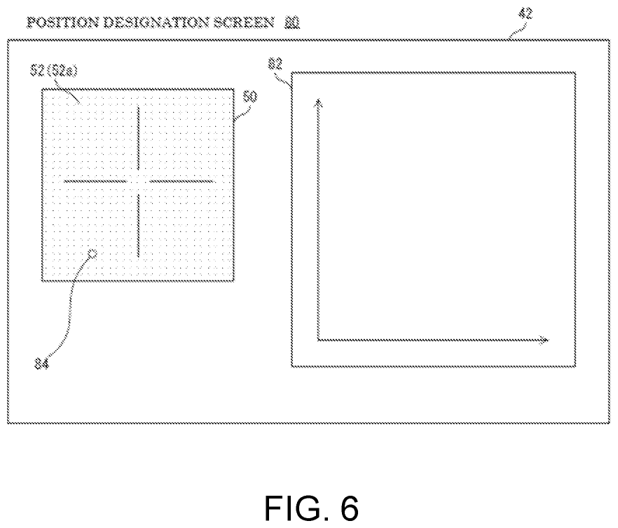

FIG. 6 is a schematic diagram illustrating an example of a position designation screen 80. The position designation screen 80 is provided with the image display area 50 and a spectrum display area 82. Further, the part 52a of the visible image 52 is displayed in the image display area 50.

In the present embodiment, the photographed portion 64 on the stage 14 may be changed by movement of the stage 14 in the horizontal direction. The change of the photographed portion 64 on the stage 14 is performed by operation on the operation unit 40, but a method of the operation is optional. For example, a software key (not illustrated) may be provided on the position designation screen 80, and when the software key is operated, the stage 14 may move in the horizontal direction.

Further, in the present embodiment, since the visible image 52 is displayed in association with the stage coordinates 62, in a case where a measurement position 84 is designated on the visible image 52, a point on the coordinates corresponding to the measurement position 84 is designated. In the infrared spectroscopic analysis or the Raman spectroscopic analysis, measurement is performed after the optical axis position 56 of light from the light source 24 or the light source 32 is matched with a designated point (measurement position) on coordinates.

A Raman spectrum or an infrared spectrum acquired by measurement performed at the measurement position 84 is displayed in the spectrum display area 82. These spectra may be displayed side by side or may be displayed in an overlapping manner.

In the present embodiment, when a Raman spectrum or an infrared spectrum is acquired, spectrum information and measurement position information are stored in the storage unit 106. The spectrum information is information indicating a Raman spectrum or an infrared spectrum. The measurement position information is information indicating the measurement position 84 designated when a Raman spectrum or an infrared spectrum is acquired.

Further, in this case, the spectrum information, the measurement position information, and the map information are associated with each other. That is, in the present embodiment, a Raman spectrum or an infrared spectrum is associated with a point on the stage coordinates 62.

### 5. Switching Between Raman Spectroscopic Analysis and Infrared Spectroscopic Analysis

In the infrared Raman microscope 10 described above, it is possible to switch between the infrared analysis state and the Raman analysis state as described above. Hereinafter, an example of operation will be described with reference to FIG. 6.

For example, when the infrared Raman microscope 10 is switched from the infrared analysis state to the Raman analysis state, as the scale of the stage coordinates 62 is adjusted, the visible image 52 photographed by the optical photographing element 28 is associated with the stage coordinates 62, and the part 52a of the visible image 52 is displayed in the image display area 50 such that the optical axis position 56 of light from the light source 24 is at the center.

Further, when the infrared Raman microscope 10 is in the Raman analysis state, the measurement position 84 is designated, and when a Raman spectrum at the measurement position 84 is acquired, the Raman spectrum is associated with a point corresponding to the measurement position 84 of the stage coordinate 62. Further, the Raman spectrum is displayed in the spectrum display area 82.

When the infrared Raman microscope 10 is switched from the Raman analysis state to the infrared analysis state after a Raman spectrum is acquired in this manner, the visible image 52 photographed by the optical photographing element 36 is associated with the stage coordinates 62, and the part 52a of the visible image 52 is displayed in the image display area 50 such that the optical axis position 56 of light from the light source 32 is at the center. At this time, the scale of the stage coordinates 62 is adjusted according to a magnification of the visible image 52 photographed by the optical photographing element 36, and the measurement position 84 already designated is identifiably displayed in the image display area 50.

As described above, even in a case where the infrared Raman microscope 10 is switched from the infrared analysis state to the Raman analysis state, the measurement position 84 is continuously used, and an infrared spectrum can be acquired by designation of the same measurement position 84. Note that the same applies to a case where the infrared Raman microscope 10 is switched from the Raman analysis state to the infrared analysis state.

### 6. Specific Example of Electrical Configuration of Infrared Raman Microscope

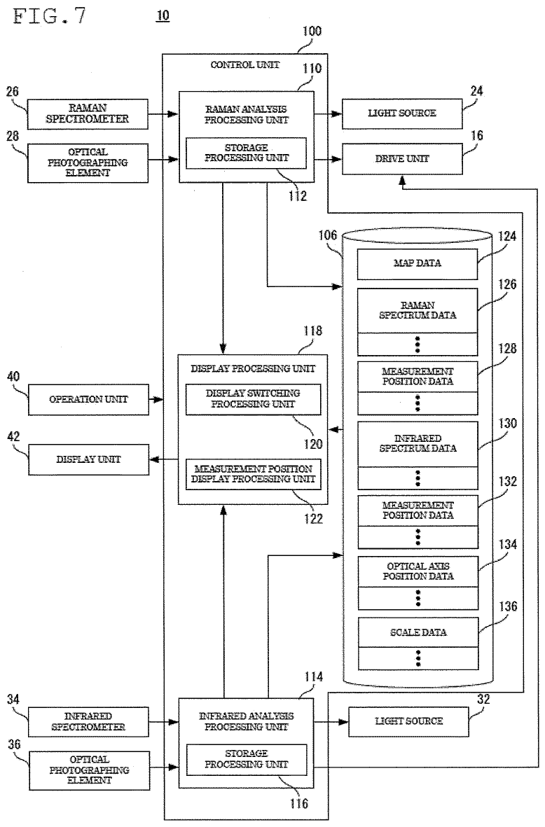

FIG. 7 is a functional block diagram illustrating a specific example of an electrical configuration of the infrared Raman microscope 10. The control unit 100 functions as a Raman analysis processing unit 110, an infrared analysis processing unit 114, a display processing unit 118, and the like when the CPU 102 (see FIG. 3) executes a program.

Further, the Raman analysis processing unit 110 includes a storage processing unit 112, the infrared analysis processing unit 114 includes a storage processing unit 116, and the display processing unit 118 includes a display switching processing unit 120 and a measurement position display processing unit 122. Note that, in FIG. 7, illustration of the RAM 104 and the like is omitted.

The Raman analysis processing unit 110 executes processing for performing the Raman spectroscopic analysis on the sample S on the stage 14. The Raman analysis processing unit 110 acquires the visible image 52 using the optical photographing element 28. Further, when the measurement position 84 is designated, the Raman analysis processing unit 110 generates Raman spectrum data 126 by the Raman spectroscopic analysis for the measurement position 84. Note that the Raman spectrum data 126 is data corresponding to spectrum information indicating a Raman spectrum.

The storage processing unit 112 stores the Raman spectrum data 126 in the storage unit 106. Further, in a case where the measurement position 84 of the Raman spectroscopic analysis is designated on the image display area 50, the storage processing unit 112 generates measurement position data 128 and stores the generated data in the storage unit 106. Note that the measurement position data 128 is data corresponding to measurement position information in the Raman spectroscopic analysis.

Further, when storing the Raman spectrum data 126 and the measurement position data 128 in the storage unit 106, the storage processing unit 112 associates each of the Raman spectrum data 126, the measurement position data 128, and map data 124 with each other. Note that the map data 124 is data corresponding to the map information.

The infrared analysis processing unit 114 executes processing for performing the infrared spectroscopic analysis on the sample S on the stage 14. The infrared analysis processing unit 114 acquires the visible image 52 using the optical photographing element 36. Further, when the measurement position 84 is designated, the infrared analysis processing unit 114 generates infrared spectrum data 130 by the infrared spectroscopic analysis for the measurement position 84. The infrared spectrum data 130 is data corresponding to spectrum information indicating an infrared spectrum.

The storage processing unit 116 stores the infrared spectrum data 130 in the storage unit 106. Further, in a case where the measurement position 84 for the infrared spectroscopic analysis is designated on the image display area 50, the storage processing unit 116 generates measurement position data 132 and stores the generated data in the storage unit 106. Note that the measurement position data 132 is data corresponding to measurement position information in the infrared spectroscopic analysis.

Further, when storing the infrared spectrum data 130 and the measurement position data 132 in the storage unit 106, the storage processing unit 116 associates each of the infrared spectrum data 130, the measurement position data 132, and the map data 124 with each other.

The display processing unit 118 uses optical axis position data 134 in the Raman analysis state to display the visible image 52 photographed by the optical photographing element 28 in the image display area 50 such that the optical axis position 56 of the light source 24 is at the center. Note that the optical axis position data 134 is data corresponding to the optical axis position information. In the infrared analysis state, the display processing unit 118 uses the optical axis position data 134 to display the visible image 52 photographed by the optical photographing element 36 in the image display area 50 such that the optical axis position 56 of the light source 32 is at the center.

Furthermore, the display processing unit 118 displays the visible image 52 photographed by the optical photographing element 28 in the image display area 50 in association with the stage coordinates 62 by using the map data 124 and scale data 136 in the Raman analysis state. Note that the scale data 136 is data corresponding to the scale information. Furthermore, in the infrared analysis state, the display processing unit 118 displays the visible image 52 photographed by the optical photographing element 36 in the image display area 50 in association with the stage coordinates 62 by using the map data 124 and the scale data 136.

The display switching processing unit 120 switches and displays the visible image 52 photographed by the optical photographing element 28 or the visible image 52 photographed by the optical photographing element 36 with respect to the image display area 50. That is, in the Raman analysis state, the visible image 52 photographed by the optical photographing element 28 is displayed in the image display area 50, and in the infrared analysis state, the visible image 52 photographed by the optical photographing element 36 is displayed in the image display area 50.

Further, the display switching processing unit 120 displays the visible image 52 photographed by the optical photographing element 28 in the image display area 50 such that the optical axis position 56 of light emitted from the light source 24 to the sample S is at the center of the image display area 50 in the Raman analysis state, and displays the visible image 52 photographed by the objective optical element 20 in the image display area 50 such that the optical axis position 56 of light emitted from the light source 32 to the sample S is at the center of the image display area 50 in the infrared analysis state.

In a case where the visible image 52 is switched and displayed by the display switching processing unit 120, the measurement position display processing unit 122 adjusts scale of the stage coordinates 62 according to a magnification of the visible image 52 photographed by the optical photographing element 28 or a magnification of the visible image 52 photographed by the optical photographing element 36, and displays the measurement position 84 in the image display area 50. That is, in the Raman analysis state, scale of the stage coordinates 62 is adjusted according to a magnification of the visible image 52 photographed by the optical photographing element 28, and the measurement position 84 is displayed in the image display area 50. In the infrared analysis state, scale of the stage coordinates 62 is adjusted according to a magnification of the visible image 52 photographed by the optical photographing element 36, and the measurement position 84 is displayed in the image display area 50.

### 5. Aspect

It is understood by those skilled in the art that a plurality of the exemplary embodiments described above are specific examples of an aspect below.

(Item 1) An infrared Raman microscope according to an aspect is an infrared Raman microscope capable of switching to and performing infrared spectroscopic analysis or Raman spectroscopic analysis on a sample on a stage. The infrared Raman microscope may include:

an infrared light detection system including an infrared light source, an infrared spectrometer that receives reflected light from a sample irradiated with light from the infrared light source, and an infrared photographing element that photographs a visible image of a sample on the stage;

a Raman light detection system including a laser light source, a Raman spectrometer that receives Raman scattered light from a sample irradiated with light from the laser light source, and a Raman photographing element that photographs a visible image of a sample on the stage at a magnification different from that of the infrared photographing element;

a display unit that displays a visible image of a sample in a display area in association with coordinates on the stage;

a display switching processing unit that switches and displays a visible image photographed by the infrared photographing element or a visible image photographed by the Raman photographing element with respect to the same display area; and

a storage processing unit that stores a point of coordinates on the stage corresponding to a measurement position of infrared spectroscopic analysis or Raman spectroscopic analysis in a case where the measurement position is designated on the display area.

According to the infrared Raman microscope described in Item 1, a visible image of a sample is displayed in the display area in association with coordinates on the stage both when the infrared spectroscopic analysis is performed and when the Raman spectroscopic analysis is performed, and a point of coordinates on the stage corresponding to a measurement position can be stored as the measurement position is designated on the display area. Accordingly, it is possible to easily designate a measurement position at the time of switching to and performing the infrared spectroscopic analysis or the Raman spectroscopic analysis.

Further, according to the infrared Raman microscope described in Item 1, since a visible image of a sample is associated with coordinates on the stage, a measurement position when the infrared spectroscopic analysis or the Raman spectroscopic analysis is switched to and performed can be managed by common coordinates on the stage.

(Item 2) The infrared Raman microscope according to Item 1 may further include a measurement position display processing unit that, in a case where a visible image is switched and displayed by the display switching processing unit, adjusts scale of coordinates on the stage according to a magnification of a visible image photographed by the infrared photographing element or a magnification of a visible image photographed by the Raman photographing element and displays the measurement position in the display area.

According to the infrared Raman microscope described in Item 2, even in a case where a visible image is switched and displayed in the infrared spectroscopic analysis and the Raman spectroscopic analysis, the same measurement position can be displayed on the visible screen in the infrared spectroscopic analysis and the Raman spectroscopic analysis as scale of coordinates on the stage is appropriately adjusted.

(Item 3) In the infrared Raman microscope according to Item 1 or 2, the display switching processing unit may cause a visible image photographed by the infrared photographing element to be displayed in the display area such that an optical axis of light emitted from the infrared light source to a sample is at the center of the display area, and cause a visible image photographed by the Raman photographing element to be displayed in the display area such that an optical axis of light emitted from the laser light source to a sample is at the center of the display area.

According to the infrared Raman microscope described in Item 3, since an optical path relating to the infrared spectroscopic analysis is different from an optical path relating to the Raman spectroscopic analysis, even if an optical axis of a light source deviates from the center on the visible image, the visible image can be displayed such that the optical axis of the light source is at the center.

What is claimed is:

1. An infrared Raman microscope capable of switching to and performing infrared spectroscopic analysis or Raman spectroscopic analysis on a sample on a stage, the infrared Raman microscope comprising:
an infrared light detection system including an infrared light source, an infrared spectrometer that receives reflected light from a sample irradiated with light from the infrared light source, and an infrared photographing element that photographs a visible image of a sample on the stage;
a Raman light detection system including a laser light source, a Raman spectrometer that receives Raman scattered light from a sample irradiated with light from the laser light source, and a Raman photographing element that photographs a visible image of a sample on the stage at a magnification different from that of the infrared photographing element;
a display unit that displays a visible image of a sample in a display area in association with coordinates on the stage;
a display switching processing unit that switches and displays a visible image photographed by the infrared photographing element or a visible image photographed by the Raman photographing element with respect to the same display area; and
a storage processing unit that stores a point of coordinates on the stage corresponding to a measurement position of infrared spectroscopic analysis or Raman spectroscopic analysis in a case where the measurement position is designated on the display area.

2. The infrared Raman microscope according to claim 1, further comprising a measurement position display processing unit that, in a case where a visible image is switched and displayed by the display switching processing unit, adjusts a scale of coordinates on the stage according to a magnification of a visible image photographed by the infrared photographing element or a magnification of a visible image photographed by the Raman photographing element and displays the measurement position in the display area.

3. The infrared Raman microscope according to claim 1, wherein
the display switching processing unit causes a visible image photographed by the infrared photographing element to be displayed in the display area such that an optical axis of light emitted from the infrared light source to a sample is at a center of the display area, and causes a visible image photographed by the Raman photographing element to be displayed in the display area such that an optical axis of light emitted from the laser light source to a sample is at a center of the display area.
